(19) United States
(12) Patent Application Publication
(10) Pub. No.: US 2007/0044830 A1
(43) Pub. Date: Mar. 1, 2007

(54) Thin film solar module and method for manufacturing the same

(75) Inventor: Hiroki Uemura, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/507,473

(22) Filed: Aug. 22, 2006

(30) Foreign Application Priority Data
Aug. 29, 2005 (JP) 2005-248157

(51) Int. Cl. H02N 6/00

(52) U.S. Cl. 136/251

(57) ABSTRACT

A thin film solar module includes a frame-like spacer formed by being adhered to a translucent substrate around a thin film solar cell formed on a rear face of the translucent substrate; a low-resilience resin section filled within the frame of the spacer and covering the thin film solar cell; and a rear side sheet covering a surface (outer side) of the low-resilience resin section. It should be noted that the rear side sheet is adhered to the low-resilience resin section and the spacer.

This application claims priority under 35 U.S.C. §119(a) on patent application Ser. No. 2005-248157 filed in Japan on Aug. 29, 2005, the entire contents of which are hereby incorporated by reference.

### BACKGROUND OF THE INVENTION

The present invention relates to a thin film solar module providing a thin film solar cell formed on a translucent substrate, and to a method for manufacturing the same.

FIG. 7 is an exploded perspective view illustrating the structure of a solar module according to a conventional example.

A solar module 101 according to this conventional example is formed by laminating a translucent substrate 102 made of reinforced glass, an adhesive sheet 103, a multiple solar cell 104 made of a plurality of connected crystal solar cells, an adhesive sheet 105, and a rear side sheet 106 in that order and adhering them together.

The multiple solar cell 104 is generally extremely thin, with a thickness of roughly several hundred micrometers; consequently, there is the problem that the multiple solar cell 104 is mechanically weak. As a countermeasure to prevent the multiple solar cell 104 being broken and scattered under the influence of an external force, its mechanical strength is enhanced using a construction wherein the multiple solar cell 104 is held by the translucent substrate 102, which is made of reinforced glass.

Accordingly, the thickness of the translucent substrate 102 (that is, reinforced glass) must be such that sufficient mechanical strength is realized, and since reinforced glass thick enough to satisfy the required specification strength is employed, there is the problem that the weight of the multiple solar cell 104 increases.

The multiple solar cell 104 is sandwiched between the adhesive sheet 103 and the adhesive sheet 105 such that it is adhered to the translucent substrate 102 and the rear side sheet 106 that are disposed on the corresponding two opposite sides thereof. In consideration of adhesiveness and moisture resistance, the adhesive sheet 103 and the adhesive sheet 105 generally comprise ethylene-vinyl acetate (EVA) sheeting. In consideration of moisture resistance, the rear side sheet 106 generally comprises polyethylene terephthalate (PET) film.

This type of solar module having a laminated structure has been disclosed in, for example, JP 2001-7376A and JP H11-31834A.

However, this conventional technology has the following problems.

As described above, the application of reinforced glass causes the weight of the solar module to increase, and furthermore, bonding of the multiple solar cell on both sides thereof increases the number of components.

Furthermore, in order to melt the EVA sheeting and complete cross-linking therein, it is necessary to perform heat treatment (i.e. a high-temperature process) for several hours at a high temperature of between 120° C. and 150° C. As the multiple solar cell 104 is therefore exposed to thermal stress over a long period of several hours in a high temperature condition, aging and property variation of a level that cannot be ignored occur in the multiple solar cell 104 during the manufacturing process.

Furthermore, as the conventional technology requires devices such as laminators that heat the reinforced glass (of the translucent substrate 102), PET (of the rear side sheet 106), and EVA sheeting (of the adhesive sheet 103 and the adhesive sheet 105) while also applying pressure thereto or heating ovens that cure the EVA sheeting, equipment costs, space occupied by equipment, and power consumption become excessive, and as a result, the cost of the solar module increases.

In view of the above-described problems, it is an object of the present invention to provide a thin film solar module that makes possible solar modules of lower weight, with less components, and of lower cost by simplifying the structure and manufacturing process thereof through the covering of a thin film solar cell formed on a rear face of a translucent substrate with a low-restitution resin and a rear side sheet, and a method for manufacturing the same.

### SUMMARY OF THE INVENTION

The thin film solar module of the present invention includes a translucent substrate, a thin film solar cell formed on a rear face of the translucent substrate, a low-resilience resin section covering the thin film solar cell, and a rear side sheet covering the low-resilience resin section.

With this configuration, the low-resilience resin section holds (or covers or secures through adhesion) the thin film solar cell in a mechanically stable condition; therefore, it is possible to prevent scattering of the thin film solar cell under the influence of an external force and to reduce the weight of the translucent substrate, thus making possible a highly reliable thin film solar module with low weight and good moisture resistance. That is to say, the present invention makes possible a highly reliable, low cost, lightweight, and mechanically stable thin film solar module with good moisture resistance and few components by simplifying its configuration, using a simple structure wherein the low-resilience resin section and the rear side sheet are attached (or glued) to the thin film solar cell formed on the rear face of the translucent substrate.

The thin film solar module according to the present invention may also include a spacer enclosing the low-resilience resin section at the outer periphery between the translucent substrate and the rear side sheet.

As this configuration enables accurate definition of the shape of the low-resilience resin section (in terms of thickness and space occupied), it is possible to realize low-resilience resin sections with a high degree of dimensional stability.

In the thin film solar module according to the present invention, the spacer can be formed of a moisture-proof material.

This configuration thus prevents the penetration of moisture into the low-resilience resin section and the penetration of moisture into the thin film solar cell, making possible highly reliable thin film solar modules.

In the thin film solar module according to the present invention, the moisture-proof material may be butyl rubber.

This configuration makes it possible to easily form the spacer with good moldability and excellent adhesiveness and water resistance.

In the thin film solar module according to the present invention, the low-resilience resin section may contain acrylic-based resin as its principal component.

This configuration makes it possible to form the low-resilience resin section using a low temperature process.

A method for manufacturing a thin film solar module according to the present invention is a method for manufacturing a thin film solar module including a translucent substrate, a thin film solar cell formed on a rear face of the translucent substrate, a low-resilience resin section covering the thin film solar cell, a rear side sheet covering the low-resilience resin section, and a spacer enclosing the low-resilience resin section at an outer periphery between the translucent substrate and the rear side sheet, and includes

a step of adhering the rear side sheet to the translucent substrate via the spacer;

a step of injecting low-restitution resin between the thin film solar cell and the rear side sheet via an injection opening provided in an edge surface of the spacer; and

a step of forming the low-restitution resin member by curing the low-restitution resin.

As this configuration makes it possible to easily form the low-resilience resin section such that it can hold (or cover or secure through adhesion) the thin film solar cell in a mechanically stable condition, a highly reliable thin film solar module with low weight and good moisture resistance can be easily manufactured. That is to say, with the method for manufacturing a thin film solar module according to the present invention, it becomes possible to easily manufacture a low cost, highly reliable thin film solar module with a low degree of thermal stress, as the forming of the low-resilience resin section capable of holding (or covering or securing through adhesion) the thin film solar cell in a mechanically stable condition through the injection and curing of low-restitution resin allows a low-temperature process to be employed as the manufacturing process thereof.

During the step of injecting the low-restitution resin in the method for manufacturing a thin film solar module according to the present invention, the translucent substrate may be placed upright and an exhaust opening may be provided in the end surface in which the injection opening is provided.

This configuration makes it possible to easily form the low-resilience resin section with no inclusion of bubbles and with a high degree of dimensional stability.

The step of injecting the low-restitution resin and the step of forming the low-resilience resin section in the method for manufacturing a thin film solar module according to the present invention may be carried out with a parallel plate constituting a plane that is parallel to that of the translucent substrate brought into contact with the rear side sheet.

With this configuration, it is possible to prevent deformation of the rear side sheet and maintain parallelism thereof with respect to the translucent substrate, thus stabilizing the resin injection volume and making possible a thin film solar module having a rear side sheet with a stable planar shape and without unevenness.

In the method for manufacturing a thin film solar module according to the present invention, the low-restitution resin may be subjected to defoaming treatment.

This configuration prevents the inclusion or mixing in of bubbles, making it possible to form a highly reliable low-resilience resin section with a low level of bubble inclusion.

In the method for manufacturing a thin film solar module according to the present invention, the surface of the rear side sheet opposing the thin film solar cell may be subjected to corona treatment.

This configuration realizes a rear surface sheet with good adhesiveness and sealing properties with respect to the low-resilience resin section, making it possible to form a highly reliable low-resilience resin section with good hermetic properties.

### BRIEF DESCRIPTION OF THE DRAWINGS

FIGS. 1 (A) and 1 (B) are diagrams illustrating the structure of a thin film solar module according to Embodiment 1 of the present invention. FIG. 1 (A) is a side elevation view of a translucent substrate with a thin film solar cell formed on a rear face thereof FIG. 1 (B) is an exploded perspective view of the thin film solar module.

FIGS. 2 (A) and 2 (B) are diagrams illustrating a method for manufacturing a thin film solar module according to Embodiment 2 of the present invention. FIG. 2 (A) is an exploded perspective view of a thin film solar module. FIG. 2 (B) is a perspective view of the thin film solar module.

FIG. 3 is a diagram illustrating a method for manufacturing a thin film solar module according to Embodiment 2 of the present invention.

FIGS. 4 (A) through 4 (C) are diagrams illustrating a method for manufacturing a thin film solar module according to Embodiment 2 of the present invention. FIG. 4 (A) is a perspective view thereof. FIGS. 4 (B) and 4 (C) are schematic side views illustrating the effect of a parallel plate making direct contact with a rear side sheet.

FIG. 5 is a diagram illustrating a method for manufacturing a thin film solar module according to Embodiment 2 of the present invention.

FIGS. 6 (A) and 6 (B) are diagrams illustrating a thin film solar module wherein a low-resilience resin section was formed by curing low-restitution resin. FIG. 6 (A) is a perspective view of a thin film solar module. FIG. 6 (B) is a transparent side view showing a spacer and a low-resilience resin section.

FIG. 7 is an exploded perspective view illustrating the structure of a solar module according to the prior art.

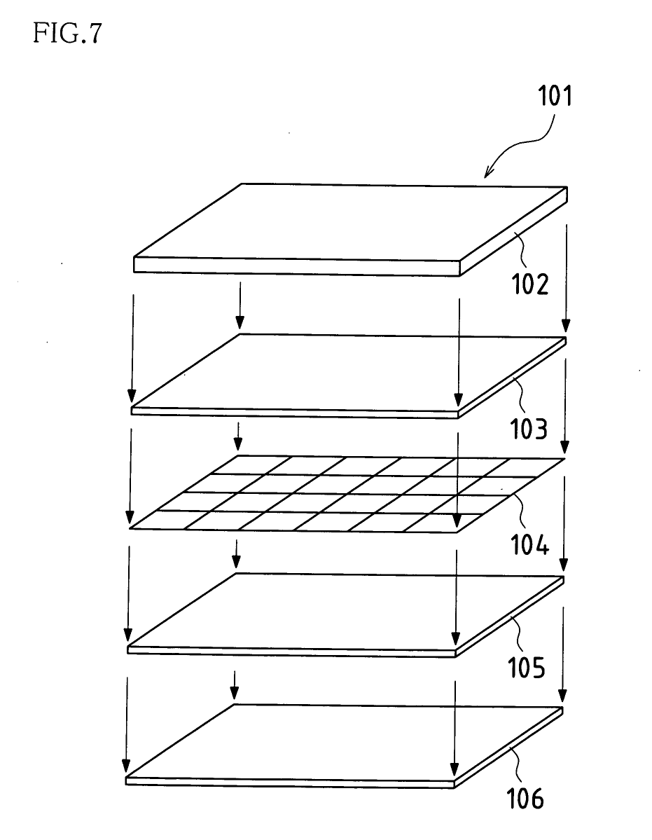

### DESCRIPTION OF THE PREFERRED EMBODIMENTS

The following is a description of preferred embodiments of the present invention, with reference to the accompanying drawings.

Embodiment 1

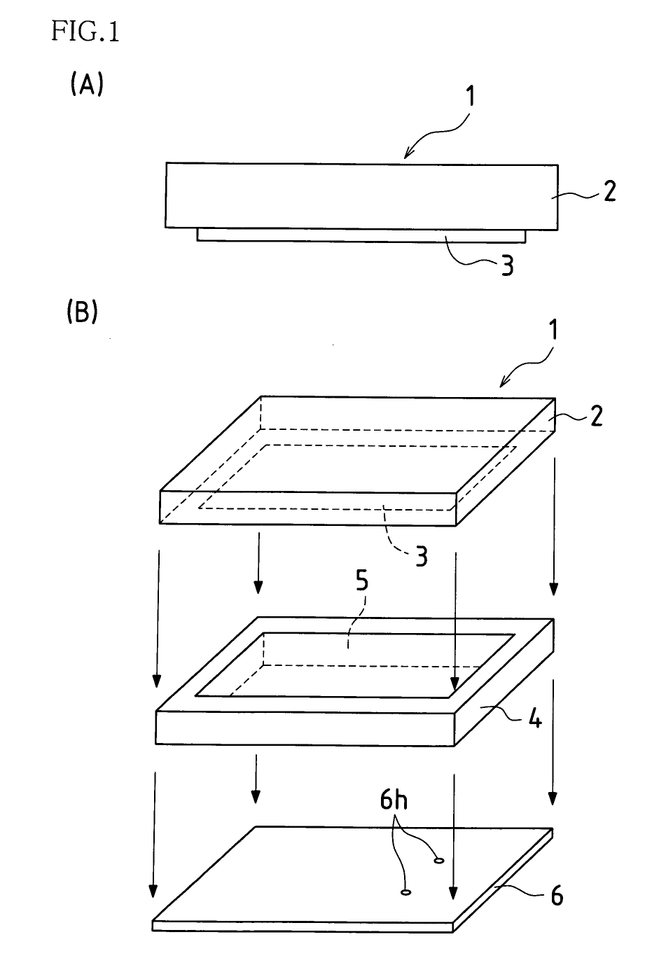

FIGS. 1 (A) and 1 (B) are diagrams illustrating the structure of a thin film solar module according to Embodiment 1 of the present invention. FIG. 1 (A) is a side elevation view of a translucent substrate with a thin film solar cell formed on a rear face thereof, and FIG. 1 (B) is an exploded perspective view of the thin film solar module.

The thin film solar module 1 according to this embodiment provides a thin film solar cell 3 formed on a rear face of a translucent substrate 2 (see FIG. 1 (A)). The translucent substrate 2 is, for example, a glass substrate, and in addition to receiving incident sunlight on a surface thereof and guiding the sunlight onto the thin film solar cell 3, the translucent substrate 2 protects the thin film solar cell 3 from an external environment.

As it is sufficient that the translucent substrate 2 holds the thin film solar cell 3 for the purpose of manufacture thereof, the translucent substrate 2 may, for example, be made of a substrate of approximately 1 to several millimeters in thickness, thus reducing weight and cost.

Manufacture of the thin film solar cell 3 can be achieved using well-known technology and it is possible to construct, for example, a non-single crystal silicon based thin-film solar cell. The thin film solar cell 3 comprises, for example, an integrated cell wherein individual cells (not shown in the drawings) are connected in an array, and by connecting the individual cells in series and in parallel, the thin film solar cell 3 can generate a large amount of electricity. It should be noted that the thin film solar cell 3 is provided with terminals, which are not shown, guided to the exterior thereof in an appropriate manner.

The thin film solar module 1 comprises a frame-like spacer 4 formed around the thin film solar cell 3 and adhered to the translucent substrate 2, a low-resilience resin section 5 filled within the frame of the spacer 4 and covering the thin film solar cell 3, and a rear side sheet 6 covering a surface (such as an outer surface) of the low-resilience resin section 5. It should be noted that the rear side sheet 6 is adhered to the low-resilience resin section 5 and the spacer 4, and is provided with terminal openings 6h for guiding electrodes (such as an output terminal) of the thin film solar cell 3 to the exterior. That is to say, the thin film solar cell 3 formed on the rear face of the translucent substrate 2 is covered by the low-resilience resin section 5, filled or injected into the space enclosed by the translucent substrate 2, spacer 4, and rear side sheet 6 (that is, the space within the frame of the spacer 4).

The low-resilience resin section 5 covers (holds, adheres to) the thin film solar cell 3, and since the low-resilience resin section 5 constitutes an adhesive material (or adhesive member) joining the translucent substrate 2 and the rear side sheet 6, it is possible to prevent scattering of the thin film solar cell 3 under the influence of an external force and to realize a mechanically stable, highly reliable thin film solar module 1.

In other words, the need for the translucent substrate 2 to comprise high-strength glass such as the reinforced glass of the conventional example is eliminated, and since the translucent substrate 2 can be made of glass with a lower strength than that of reinforced glass, it is possible to reduce the weight of the translucent substrate 2 with respect to that of a reinforced glass type configuration. As no EVA sheeting is used, the requirement to attach EVA sheeting through the application of heat is eliminated, and a low temperature manufacturing process is made possible.

The spacer 4 comprises, for example, acrylic-based double coated adhesive tape, with a thickness of, for example, approximately 1 mm, and a frame width of, for example, approximately 5 mm. The thickness of the spacer 4 can be set as appropriate, and can be determined by taking factors such as the shape of the elements of the thin film solar cell 3 and the required film thickness (or injection volume) of the low-resilience resin section 5 into account.

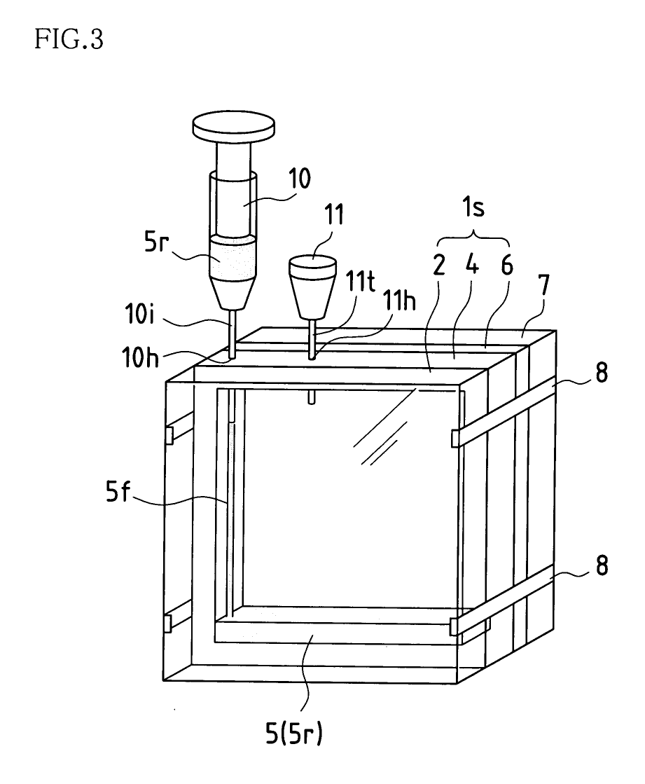

Constituting an outer periphery between the translucent substrate 2 and the rear side sheet 6, the spacer 4 defines a closed area (corresponding to the low-resilience resin section 5) wherein a low-restitution resin 5r (see FIG. 3) is filled, and therefore, the spacer 4 defines the shape of the low-resilience resin section 5. In other words, the spacer 4 is shaped so as to enclose the low-resilience resin section 5 between the translucent substrate 2 and the rear side sheet 6.

The spacer 4 can be formed into a prescribed shape using a moisture-proof material such as moisture-proof resin or rubber. Through the use of a moisture-proof material for the spacer 4, it is possible to prevent the penetration of moisture between the low-resilience resin section 5, the rear side sheet 6, and translucent substrate 2, which are layered and adhered together, and also to prevent the penetration of moisture into the low-resilience resin section 5; thus making possible a highly reliable thin film solar module 1 with good moisture resistance and free of the penetration of moisture into the thin film solar cell 3. In particular, if the spacer 4 comprises butyl rubber, its moldability is high and both its adhesiveness and water resistance are increased in a sure and reliable manner.

The low-resilience resin section 5 contains, for example, acrylic-based resin as its principal component, and is formed by curing of resin into which a catalytic liquid for the acceleration of curing has been mixed. Providing the low-restitution resin 5r (and the low-resilience resin section 5) with adhesiveness ensures that the low-restitution resin 5r is firmly adhered to the thin film solar cell 3 and the rear side sheet 6, and can prevent scattering of the thin film solar cell 3, even upon the occurrence of damage under the influence of an external force. Through the use of an acrylic-based resin into which a catalytic liquid for the acceleration of curing is mixed, curing can be realized at low temperatures, thus making it possible to form the thin film solar module 1 using a low temperature manufacturing process.

The use of, for example, a triple-layer film of polyethylene terephthalate (PET) / aluminum / PET (hereinafter “a PAP triple-layer film”) constituting the rear side sheet 6 provides a high degree of moisture resistance to the rear side sheet 6, making it possible to prevent the penetration of moisture into the low-resilience resin section 5 from the outside the rear face, and realizing a highly reliable thin film solar module 1 with good moisture resistance.

Embodiment 2

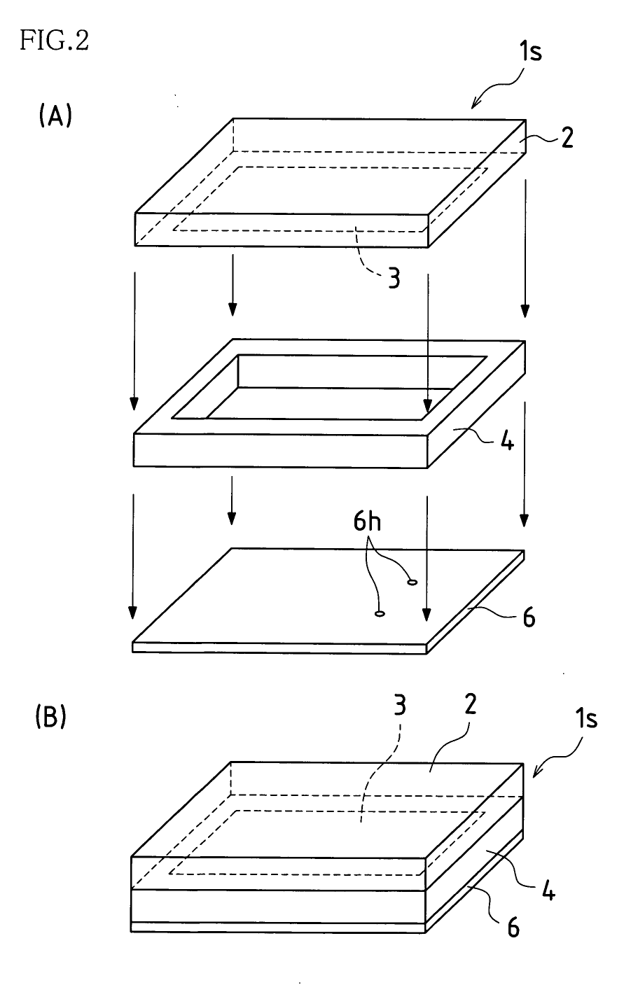

FIGS. 2 through 5 are diagrams illustrating a method for manufacturing a thin film solar module according to Embodiment 2 of the present invention.

FIGS. 2 (A) and 2 (B) are diagrams illustrating a step of mutually positioning and adhering a translucent substrate whereupon a thin film solar cell is formed, a spacer, and a rear side sheet. FIG. 2 (A) is an exploded perspective view thereof, and FIG. 2 (B) is a perspective view showing the condition thereof after adhering.

Firstly, the method for manufacturing a thin film solar module according to this embodiment includes a step of forming a thin film solar cell 3 on the rear face of a translucent substrate 2.

Next, the manufacturing method according to this embodiment includes a step of forming an intermediate thin film solar module 1s by positioning the translucent substrate 2 and the rear side sheet 6 in mutual opposition, sandwiching the spacer 4, which is disposed around the outer periphery of the thin film solar cell 3 (that is, an outer periphery of the translucent substrate 2) with a frame-like shape corresponding to the shape of the outer periphery, and adhering the translucent substrate 2 and the rear side sheet 6 to each other via the spacer 4.

More specifically, rubber or the like (butyl rubber is preferable) is applied (or adhered) to the translucent substrate 2 to constitute the spacer 4, and furthermore, a PAP triple-layer film is applied (or adhered) to the spacer 4 as the rear side sheet 6 so as to oppose the translucent substrate 2 (and the thin film solar cell 3). The spacer 4 has, for example, a thickness of several millimeters and a width of 5 millimeters. It should be noted that resin retention tape (not shown) is applied to the adhesive edge surfaces between the spacer 4 and the translucent substrate 2 and the rear side sheet 6 (that is, the edge surfaces of the intermediate thin film solar module 1s) in order to form an appropriate hermetic seal such that leakage of resin does not occur during a subsequent resin injection step.

Corona treatment is carried out on the surface of the rear side sheet 6 that faces the thin film solar cell 3. As a result of corona treatment, the surface is provided with an appropriate degree of roughness and a structure that chemically bonds readily with carboxyl groups (COOH), thus improving its adhesiveness with respect to the low-restitution resin 5r (see FIG. 3), which is injected in a subsequent step.

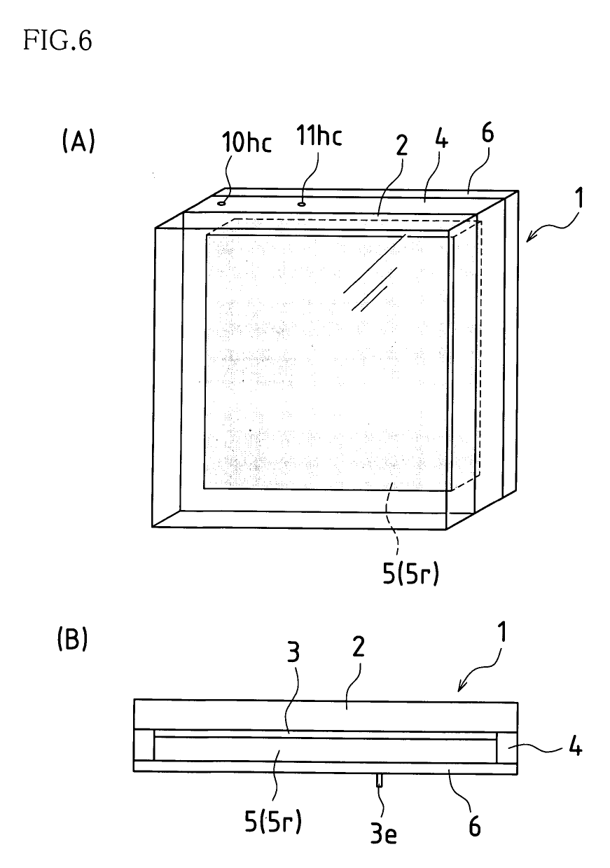

An output terminal 3e of the thin film solar cell 3 (see FIG. 6 (B)) is guided to the exterior in advance via a terminal opening 6h. Furthermore, resin retention tape (not shown) is applied at a gap between the output terminal 3e and the terminal opening 6h in order to form an appropriate hermetic seal such that leakage of resin does not occur during a subsequent resin injection step.

FIG. 3 is a perspective view illustrating a step of forming the low-residences resin section by injecting low-restitution resin via the spacer into the space formed between the translucent substrate (or the thin film solar cell) and the rear side sheet.

The method for manufacturing a thin film solar module according to this embodiment further includes a step in which, after the translucent substrate 2, the spacer 4, and the rear side sheet 6 are adhered to each other and the intermediate thin film solar module 1s is formed, a parallel plate 7 of a size identical to that of the rear side sheet 6 and constituting a parallel plane to that of the translucent substrate 2 is brought into contact with the rear side sheet 6, and the translucent substrate 2, the spacer 4, the rear side sheet 6, and the parallel plate 7 are fixed to each other using a latching jig 8. It should be noted that contact between the rear side sheet 6 and the parallel plate 7 as mentioned above refers to contact between a planar surface of the rear side sheet 6 (such as the rear surface thereof) and a planar surface of the parallel plate 7 (such as the front surface thereof).

Next, the manufacturing method according to this embodiment includes a step of supplying (injecting) the low-restitution resin 5r into the space formed between the thin film solar cell 3 (not shown in FIG. 3) and the rear side sheet 6 (that is, the space corresponding to the low-resilience resin section 5) using an injection needle 10i provided on the front end of a cylindrical resin injector 10 wherein the low-restitution resin 5r has been charged. As the injection space for the low-restitution resin 5r is defined by the spacer 4, it is possible to form the low-resilience resin section 5 with a high degree of dimensional stability and an accurate shape (in terms of thickness and space occupied).

More specifically, the intermediate thin film solar module 1s (and the translucent substrate 2) is placed upright (in other words, with the front and rear faces of the intermediate thin film solar module 1s and the parallel plate 7 oriented horizontally), and an injection opening 10h is provided in an end surface of the spacer 4 positioned on the upper side of the intermediate thin film solar module is by inserting the injection needle 10i at a central position with respect to the width of the spacer 4. As the spacer 4 is made of an elastic material such as the above-described rubber or the like, the injection needle 10i can be easily inserted therein. It should be noted that a vertical orientation of the translucent substrate 2 is preferred.

By inserting the front end of the injection needle 10i into the spacer 4 such that the injection needle injection needle 10i is disposed in direct or close contact with a wall surface thereof, the low-restitution resin 5r is injected along the wall surface of the spacer 4, as illustrated by the low-restitution resin 5f. As the low-restitution resin 5f is injected along a wall surface, the inclusion of bubbles therein can be prevented. With this configuration, the low-restitution resin 5r can be easily injected, making it easy to form the low-resilience resin section 5 free of bubbles, and to form a highly reliable low-resilience resin section 5.

It should be noted that an exhaust opening 11h leading to an exhaust jig 11 is provided at a suitable position different from that of the injection opening 10h in an end surface of the spacer 4 positioned on the upper side of the intermediate thin film solar module 1s. In other words, an exhaust opening 11h is provided in the end surface of the spacer 4 wherein the injection opening 10h is provided. The exhaust opening 11h is provided by inserting an exhaust tube 11t into the spacer 4. Making the exhaust opening 11h larger than the injection opening 10h ensures that the discharge of air can proceed in a sure and reliable manner, preventing the inclusion of bubbles in the low-resilience resin section 5. It should be noted that at least one exhaust opening 11h should be provided.

The low-restitution resin 5r has acrylic-based resin as its principal component, and after stirring therein using a stirring device (not shown), blending, and mixing of a catalytic liquid for the acceleration of curing (comprising a mixture of three catalytic liquids such as, for example, 0.75% each (by volume, with respect to the volume of the acrylic-based resin) of a vanadium based curing accelerator, cumene hydroperoxide, and an adipate based elasticizer containing organic acid), the low-restitution resin 5r was subjected to defoaming treatment by being left to stand for a period of ten minutes at a temperature of 25° C. and a pressure of 100 hPa in a vacuum oven. This defoaming treatment made it possible to prevent in a sure and reliable manner the inclusion of bubbles visible to the naked eye.

Furthermore, the low-restitution resin 5r was blended with the catalytic liquid such that its curing temperature became approximately 50° C. (between roughly 40° C. and roughly 60° C.). Although a curing temperature of approximately 50° C. is slightly higher than room temperature, it is not so high that a heating-type oven would be required; therefore, a highly reliable thin film solar module 1 can be realized by reducing the level of thermal stress to which the thin film solar module 1 (and hence the thin film solar cell 3) are subjected.

Injection of the low-restitution resin 5r continues until ejection thereof from the exhaust jig 11. Upon the ejection of low-restitution resin 5r from the exhaust jig 11, the injection of the low-restitution resin 5r is ended. Forming of the exhaust opening 11h and the injection opening 10h in the same plane makes it possible to form the low-resilience resin section 5 uniformly and with no leakage upon filling.

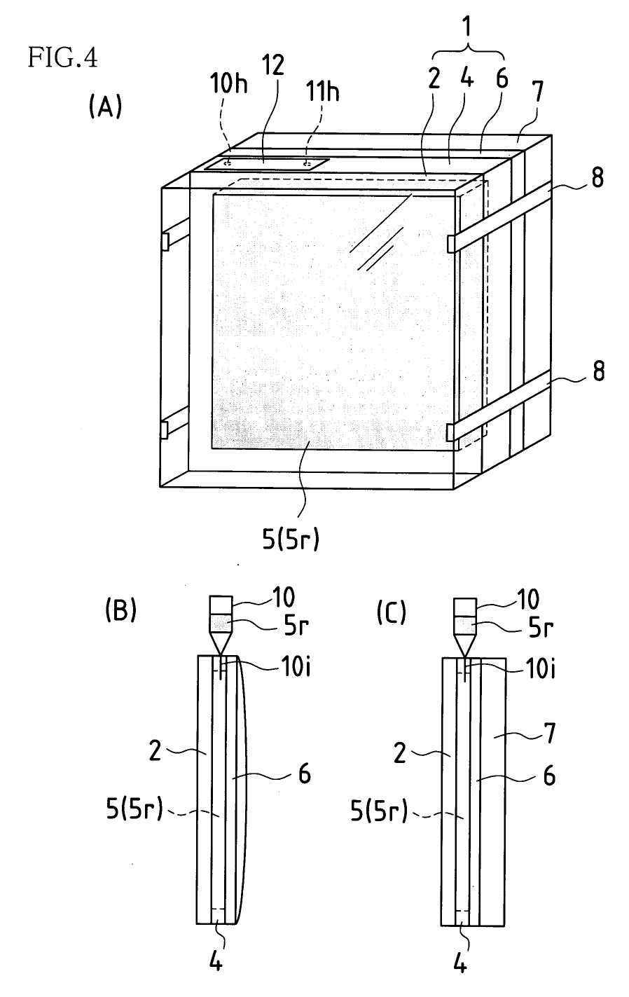

FIGS. 4 (A) through 4 (C) are diagrams illustrating a condition upon the filling of low-restitution resin into the low-resilience resin section. FIG. 4 (A) is a perspective view, and FIGS. 4 (B) and 4 (C) are schematic side views illustrating the effect of the parallel plate making direct contact with the rear side sheet.

The injection opening 10h and the exhaust opening 11h are sealed tightly using an appropriate sealing member 12 such as, for example, adhesive film after the completion of injection of the low-restitution resin 5r, thus realizing the thin film solar module 1 prior to curing of the low-restitution resin 5r (see FIG. 4 (A)).

If the low-restitution resin 5r is injected without using the parallel plate 7, then the volume of filled resin is unstable, so that the rear side sheet 6 swells as the low-restitution resin 5r is injected, resulting in the low-resilience resin section 5 and the rear side sheet 6 having uneven surfaces (see FIG. 4 (B)).

In contrast, if the low-restitution resin 5r is injected with the parallel plate 7 present, the parallel plate 7 reinforces and supports the rear side sheet 6, ensuring that the volume of filled resin is stable and that the low-resilience resin section 5 and the rear side sheet 6 retain a planar shape that is sufficiently parallel to the translucent substrate 2 (see FIG. 4(C)).

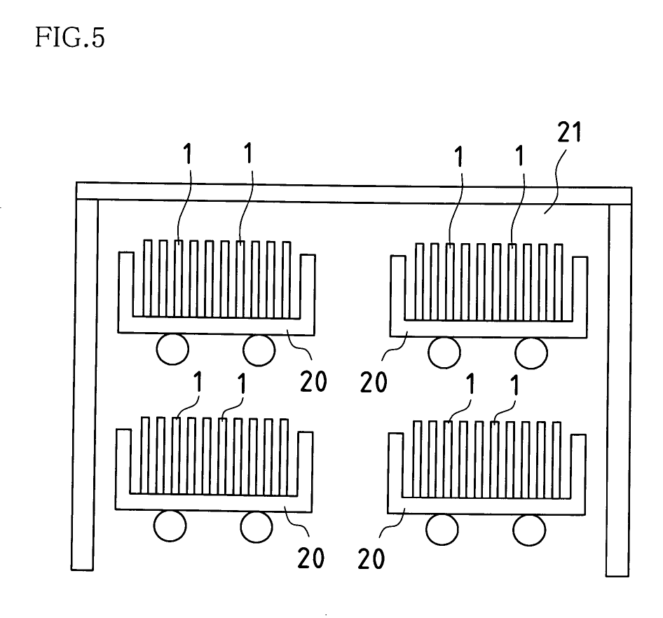

FIG. 5 is a diagram illustrating a step of curing the low-restitution resin charged to the low-resilience resin section.

This embodiment further includes a step of curing the low-restitution resin 5r and forming the low-resilience resin section 5 by placing the thin film solar module 1 prior to curing of the low-restitution resin 5r on a cassette 20, inserting the cassette 20 loaded with the thin film solar module 1 into a heating chamber 21 and allowing it to stand therein for between two and three hours.

The heating chamber 21 is set to the curing temperature of the low-restitution resin 5r of approximately 50° C. (between roughly 40° C. and roughly 60° C.). As this temperature is slightly higher than room temperature, there is no need for special heating devices such as a heating-type oven.

As the parallel plate 7 is in direct contact with the rear side sheet 6 during the step of curing the low-restitution resin 5r, the curing can take place with the low-resilience resin section 5 and the rear side sheet 6 maintaining their shape with a high degree of parallelism with respect to the translucent substrate 2. In other words, in the present embodiment, the low-restitution resin 5r is injected and cured with the parallel plate 7 in a condition of direct contact with the rear side sheet 6 and providing reinforcement thereto; therefore, it is possible to prevent deformation of the rear side sheet 6 upon the subsequent filling of the low-restitution resin 5r, and to realize a rear side sheet 6 with a stable planar shape and without unevenness.

As the curing temperature of the low-restitution resin 5r is a low temperature not requiring the use of a heating-type oven, the thermal stress to which the thin film solar cell 3 is subjected can be significantly reduced. Accordingly, consumption of electricity in the manufacturing process can be reduced, and as a result of this energy-conserving manufacturing process, the cost of the thin film solar module 1 can be reduced.

FIGS. 6 (A) and 6 (B) are diagrams illustrating a thin film solar module wherein a low-resilience resin section was formed by curing low-restitution resin. FIG. 6 (A) is a perspective view of a thin film solar module, and FIG. 6 (B) is a transparent side view showing a spacer and a low-resilience resin section.

The thin film solar module 1 is removed from the heating chamber 21 after curing of the low-restitution resin 5r. The parallel plate 7 making direct contact with the rear side sheet 6 of the thin film solar module 1 and the sealing member 12 are removed. The injection opening 10h and the exhaust opening 11h are sealed by the cured low-restitution resin 5r, providing an injection opening seal 10hc and an exhaust opening seal 11hc (see FIG. 6 (A)).

The resin retention tape (not shown) that was applied to the adhesive edge surfaces between the spacer 4 and the translucent substrate 2 and the rear side sheet 6, and the resin retention tape (not shown) that was applied at a gap between the output terminal 3e and the terminal opening 6h (see FIG. 1) in order to form a hermetic seal are also removed (see FIG. 6(B)).

In addition, a terminal box (not shown) is attached to the output terminal 3e using adhesive resin, silicone resin is filled into the terminal box after the formation of electrical connections, and a lid is applied to the terminal box to complete the thin film solar module 1 after curing of the silicone resin.

It should be noted that without departure from the intention, gist, and principal characteristics thereof, the present invention can have many other embodiments. Accordingly, the above-described embodiments are no more than simple examples and should not be interpreted in a limited manner. The scope of the present invention is set forth by the scope of the claims, and the disclosure is in no way binding. Furthermore, all modifications and changes within a scope equivalent to that of the claims are within the scope of the present invention.

1. A thin film solar module, comprising: a translucent substrate, a thin film solar cell formed on a rear face of the translucent substrate, a low-resilience resin section covering the thin film solar cell, and a rear side sheet covering the low-resilience resin section.

2. The thin film solar module of claim 1, further comprising a spacer enclosing the low-resilience resin section at an outer periphery between the translucent substrate and the rear side sheet.

3. The thin film solar module of claim 2, wherein the spacer is formed of a moisture-proof material.

4. The thin film solar module of claim 3, wherein the moisture-proof material is butyl rubber.

5. The thin film solar module of claim 1, wherein the low-resilience resin section contains acrylic-based resin as its principal component.

6. A method for manufacturing a thin film solar module comprising a translucent substrate, a thin film solar cell formed on a rear face of the translucent substrate, a low-resilience resin section covering the thin film solar cell, a rear side sheet covering the low-resilience resin section, and a spacer enclosing the low-resilience resin section at an outer periphery between the translucent substrate and the rear side sheet: the method comprising
a step of adhering the rear side sheet to the translucent substrate via the spacer;
a step of injecting low-restitution resin between the thin film solar cell and the rear side sheet via an injection opening provided in an edge surface of the spacer; and
a step of forming the low-restitution resin member by curing the low-restitution resin.

7. The method for manufacturing a thin film solar module of claim 6, wherein the step of injecting the low-restitution resin is carried out while the translucent substrate is placed upright and an exhaust opening is provided in the end surface in which the injection opening is provided.

8. The method for manufacturing a thin film solar module of claim 6, wherein the step of injecting the low-restitution resin and the step of forming the low-resilience resin section are carried out while a parallel plate constituting a plane that is parallel to that of the translucent substrate is brought into contact with the rear side sheet.

9. The method for manufacturing a thin film solar module of claim 6, wherein the low-restitution resin is subjected to defoaming treatment.

10. The method for manufacturing a thin film solar module of claim 6, wherein a surface of the rear side sheet facing the thin film solar cell is subjected to corona treatment.
